(19) United States
(12) Patent Application Publication
(10) Pub. No.: US 2010/0051667 A1
(43) Pub. Date: Mar. 4, 2010

(54) Switching mechanism for stapling modes of a stapler

(75) Inventor: Jhih-Siang Tang, Taichung (TW)

Correspondence Address: LIN, TIEN-FU, P.O.BOX 215, TAICHUNG, 40099, TW

(73) Assignee: LIN, TIEN-FU

(21) Appl. No.: 12/289,167

(22) Filed: Oct. 22, 2008

Related U.S. Application Data
(63) Continuation-in-part of application No. 12/230,185, filed on Aug. 26, 2008.

(51) Int. Cl. B25C 5/13

(52) U.S. Cl. 227/130; 227/8

(57) ABSTRACT

The purpose of this invention is to propose a switching mechanism for switching stapling modes of a stapler, which mainly comprises a trigger, a supporting member, a slide member, a spring, a hooking member and a torsion spring. When the safety device of the stapler is pushed, then it further pushes the slide member to open the air valve, then at the moment, if the trigger is further pressed, the stapling counterforce will make the slide member escape the pressure from the safety device so to finish single stapling process. When the trigger is pressed first and then the safety device is pushed to further push the slide member to open the air valve, it will make stapling contentiously until the trigger is released. Above process then makes a contentious stapling.

### BACKGROUND OF THE INVENTION

The known existing switching mechanism (switching between single and continuous stapling) for a stapler employs an eccentric rod to switch the mode by pressing and spinning it. According to actual practice, however, it is found that the eccentric rod can not be positioned at its desired location well when switching modes between single and continuous stapling, thus under the vibration environment making the stapler lose the capability of switching modes easily. The proposed invention therefore is designed aiming to solve the aforementioned drawbacks.

### BRIEF SUMMARY OF THE INVENTION

The purpose of this invention is to propose a switching mechanism for stapling modes of a stapler, which is more convenient to use compared to prior art.

The invention “A switching mechanism for stapling modes of a stapler”, which enables the switching between single and continuous stapling, comprises a trigger, a supporting member, a slide member, a spring, a hooking member and a torsion spring, wherein: the trigger is hollow with openings on top and its adjacent rear side, and has a 1^{st} pin and a 2^{nd} pin. Further, there are two symmetrical pivot holes and stopper recess on upper locations of the two sidewalls of the trigger, and the two symmetrical pivot holes cooperate with a connecting pin to pivotally connect the trigger to stapler main body; the supporting member has pivot holes at its bottom for pivotally connecting with the 1^{st} pin, and also has symmetrical convex stoppers on top of its sidewall and a protrusion at its top; the slide member has a sliding recess in one side for sliding against the supporting member, a protrusion on top, furthermore, there is a hook hole at bottom rear side of the slide member; the spring is connected between the supporting and slide members; the hooking member is connected by the 2^{nd} pin, and has a curved piece and a hook tip employed to pull the slide member; the torsion spring is fitted on the hooking member to give hooking member force to return to its original position.

When the safety device is pushed, then it further pushes the slide member to open the air valve, then at the moment, if the trigger is further pressed, the stapling counterforce will make the slide member escape the pressure from the safety device so to finish single stapling process. Next, when the trigger is pressed first, then push safety device to further push the slide member to open the air valve, which will make stapling contentiously until the trigger is released. Above process then makes a contentious stapling.

### BRIEF DESCRIPTION OF THE DRAWINGS

FIG. 1 is an exploded view to show of the preferred embodiment of the invention

FIG. 2 is a 3-D cross sectional view of the preferred embodiment of the invention

FIG. 3 is a cross sectional view of the preferred embodiment of the invention

FIG. 4 is a perspective view of the preferred embodiment of the invention when connecting to the stapler main body

FIG. 5 is a partial cross sectional view of the FIG. 4

FIG. 6 is a cross sectional view (I) of the preferred embodiment of the invention when operating single stapling mode

FIG. 7 is a cross sectional view (II) of the preferred embodiment of the invention when operating single stapling mode

FIG. 8 is a cross sectional view (III) of the preferred embodiment of the invention when operating single stapling mode

FIG. 9 is a cross sectional view (IV) of the preferred embodiment of the invention when operating single stapling mode

FIG. 10 is a cross sectional view (I) of the preferred embodiment of the invention when operating continuous stapling mode

FIG. 11 is a cross sectional view (II) of the preferred embodiment of the invention when operating continuous stapling mode

FIG. 12 is an exploded view to show of the 2^{nd} preferred embodiment of the invention

FIG. 13 is a 3-D cross sectional view of the 2^{nd} preferred embodiment of the invention

FIG. 14 is a cross sectional view of the 2^{nd} preferred embodiment of the invention

### DETAILED DESCRIPTION OF THE INVENTION

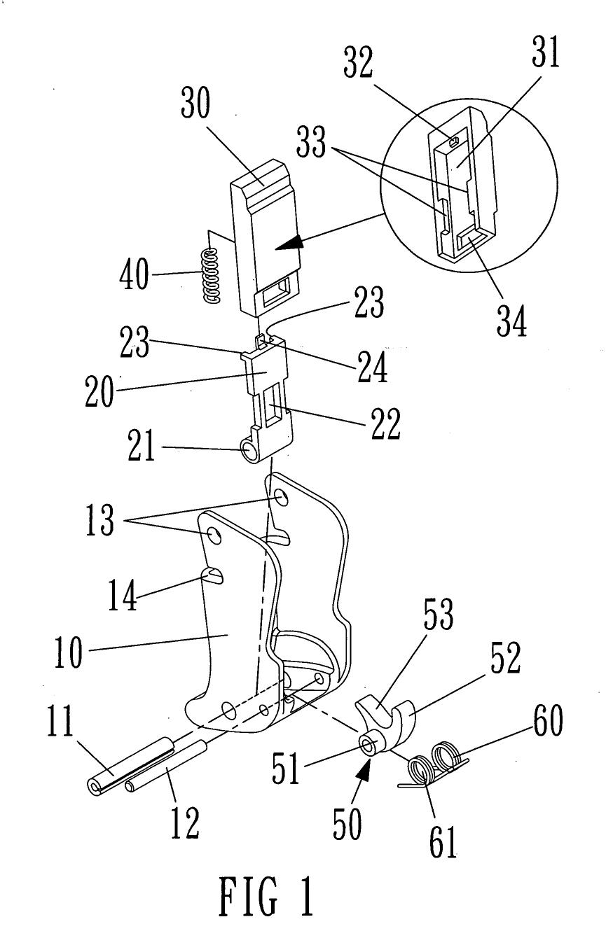

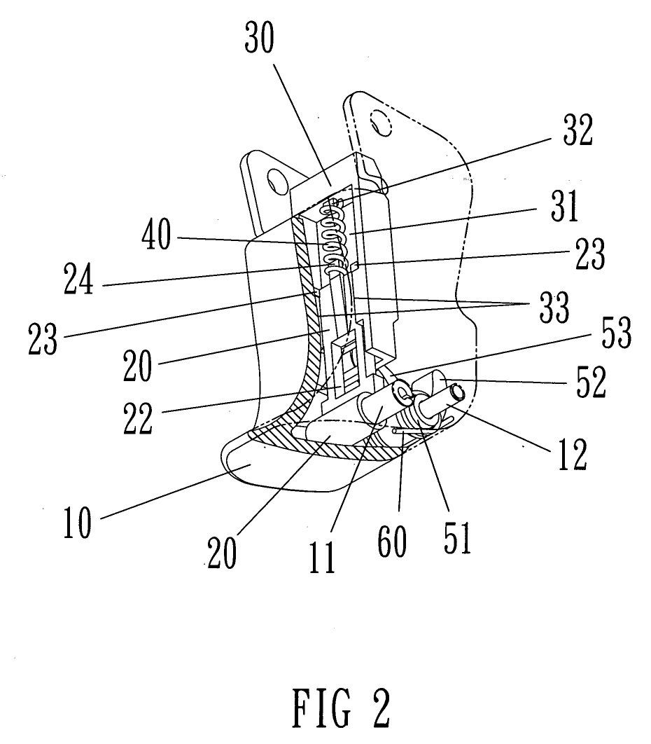

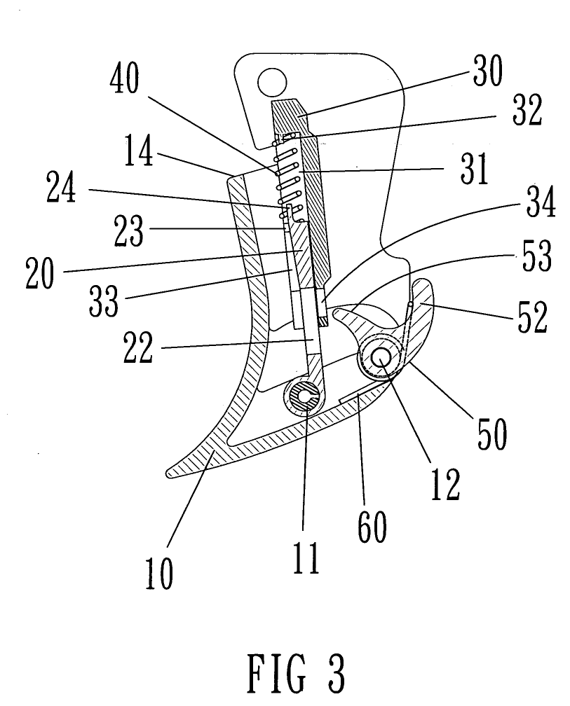

Please refer to following descriptions for the preferred embodiment for the invention. First, please refer to FIG. 1-3. The invention “A switching mechanism for stapling modes of a stapler”, which enables the switching between single and continuous stapling, comprises a trigger 10, a supporting member 20, a slide member 30, a spring 40, a hooking member 50 and a torsion spring 60, wherein:

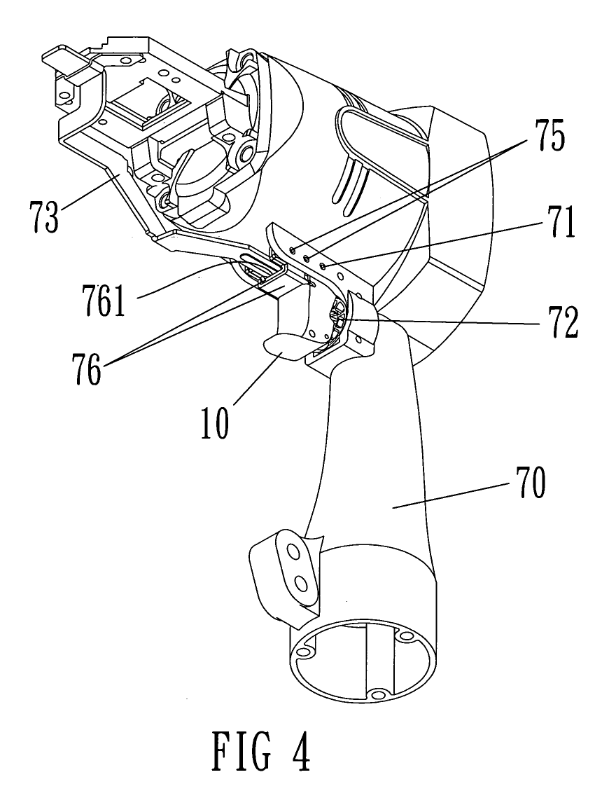

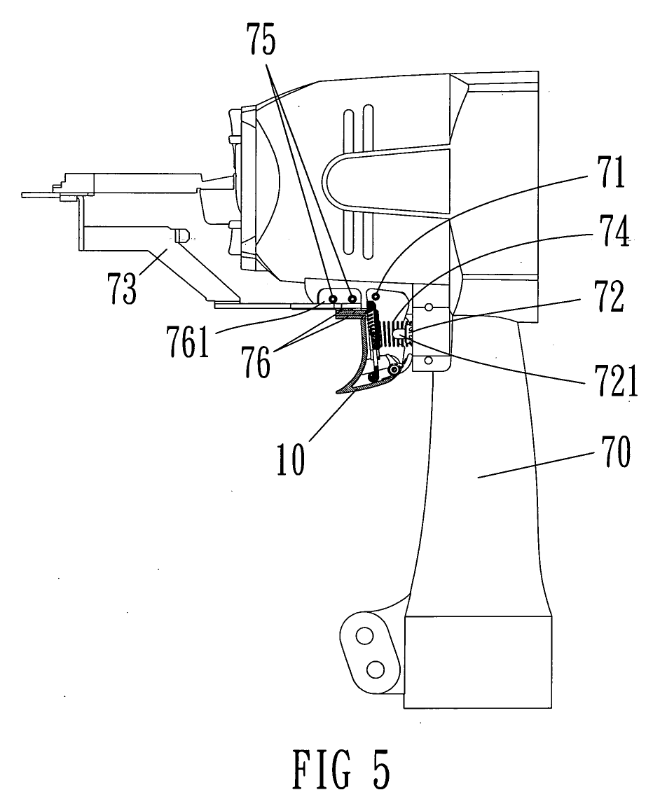

The trigger 10 is hollow with openings on top and its adjacent rear side, and has a 1^{st} pin 11 and a 2^{nd} pin 12 crossing between the sidewalls of the trigger 10 at its lower position with the 2^{nd} pin 12 closer to the open rear side. Further, there are two symmetrical pivot holes 13 and stopper recess 14 on upper locations of the two sidewalls of the trigger 10. The two symmetrical pivot holes 13 cooperate with a connecting pin 71 to pivotally connect the trigger 10 to stapler main body 70, and the two symmetrical stopper recess 14 cooperate with a positioning plate 76 of the stapler main body 70 to well position the trigger 10 (as shown in FIGS. 4, 5).

The supporting member 20 has a pivot hole 21 at its bottom for pivotally connecting with the 1^{st} pin 11, and a penetrating hole 22 in its middle location for allowing the hook tip 53 of the hooking member 50 to move through when it swings. Further, the supporting member 20 also has symmetrical convex stoppers 23 on top of its sidewall and a 1^{st} protrusion 24 at its top.

The slide member 30 has a sliding recess 31 in one side with an opening at its bottom so to allow the supporting member 20 to slide against the recess 31. Further, a 2^{nd} protrusion 32 extends from a top inner end of the recess 31, and there are two symmetrical convex blockers 33 in the inner lower middle locations of the recess 31 for cooperating with the convex stoppers 23 to limit the range the slide member 30 can slide against the supporting member 20 (namely, the slide member 30 slides to its farthest against the supporting member 20 when the convex blockers 33 are stopped against the convex stoppers 23). Furthermore, there is a hook hole 34 at bottom rear side of the slide member 30 for purpose of cooperating with the hook tip 53.

The spring 40 is connected between and fixed firmly by above said 1st and 2^{nd} protrusions 24, 32. The hooking member 50 comprises a pivot tube 51 for pivotally connecting with the 2^{nd} pin 12, a curved piece 52 to be pushed to swing the hooking member 50, and a hook tip 53 employed to hook the hook hole 34 and then pull the slide member 30 sliding against the supporting member 20.

The torsion spring 60 is fitted on the pivot tube 51 of the hooking member 50 through its spring hole 61 with its both sides staying against at inner bottom face of the trigger 10 and one side of the curve piece 52 respectively.

The FIGS. 4 and 5 shows the entire stapler and the assembly of the invention and the stapler main body 70. The trigger 10 is connected firmly to the stapler main body 70 with the connecting pin 71 and the pivot holes 13. The connection position is located between the air valve 72 and safety device 73, and the air valve 72 is located about same horizontal level as the middle part of the slide member 30. There is a spring 74 set between the air valve 72 and the slide member 30. Further, a guiding plate 76 with guiding groove 761 on its top is fixed by connecting pins 75, which is employed to guide the safety device 73 to ensure smooth movements horizontally.

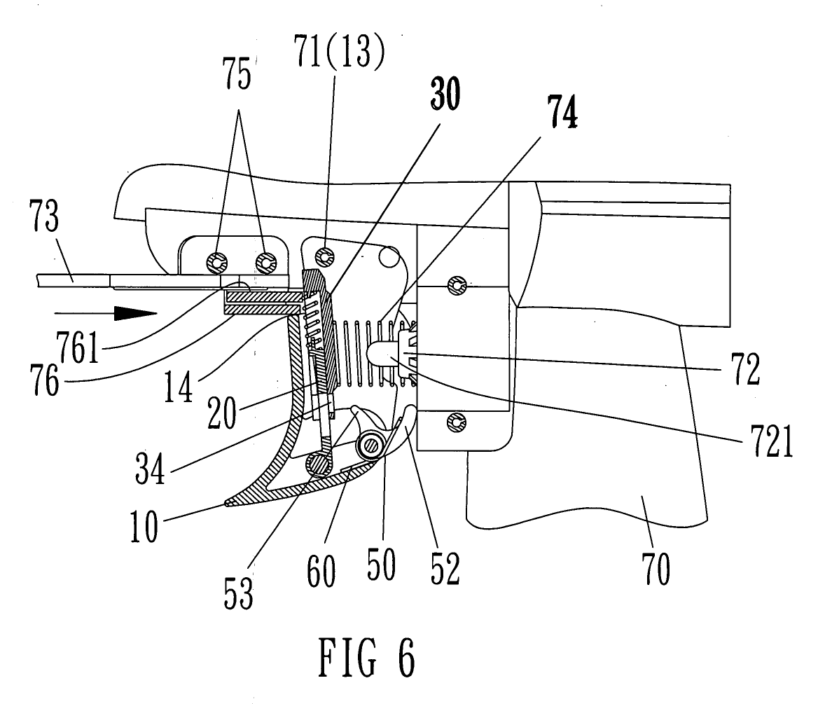

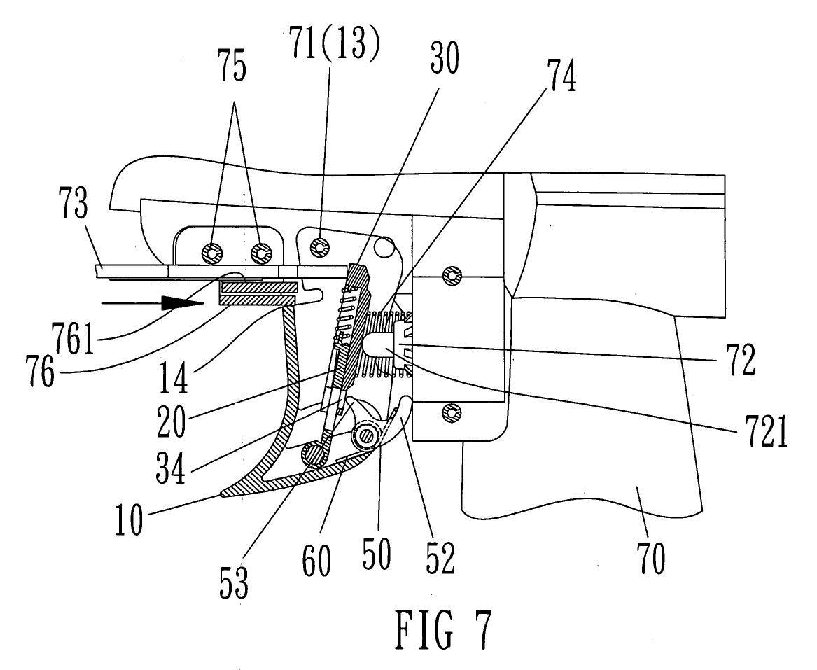

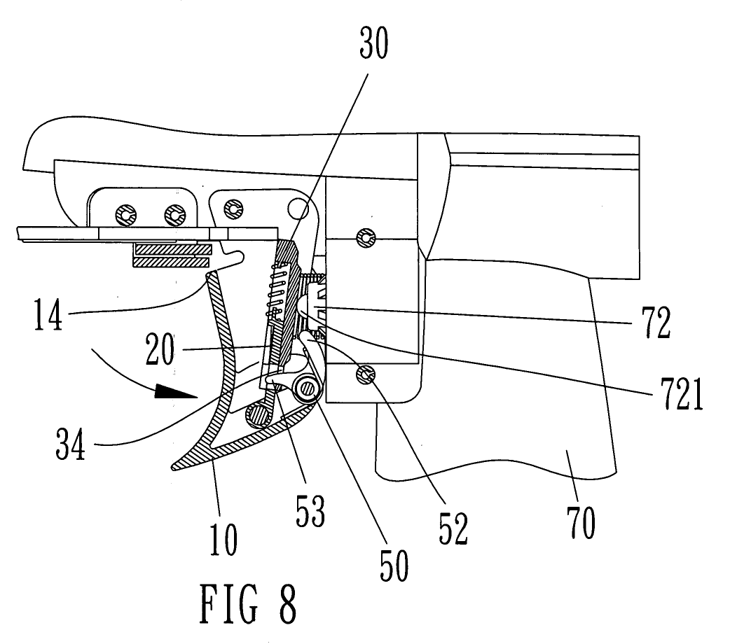

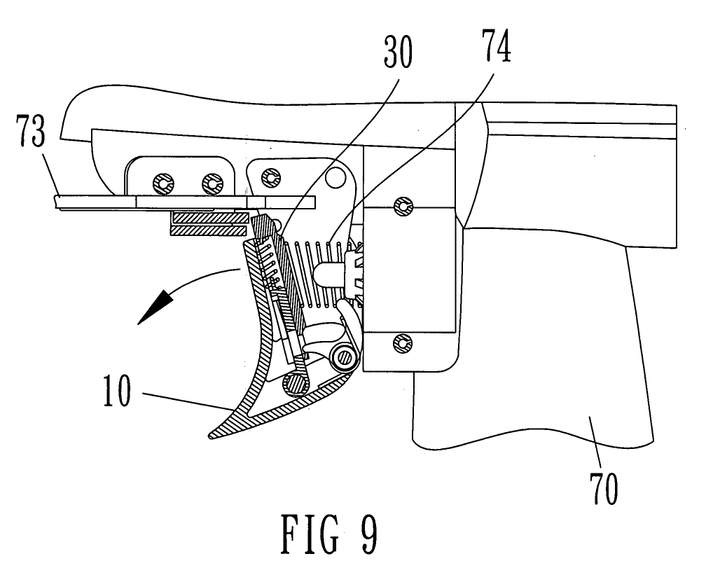

Now please refer to FIGS. 6-9 for illustrations on how single-stapling mode works. FIG. 6 shows the status when the stapler stays still. Then as shown in FIG. 7, when the safety device 72 is pushed against the surface of a work piece (not shown in the figures), the safety device 72 would then pushes the top part of slide member 30 to compress the compression spring 74, and stops at a proper position. Then at the moment, if the trigger 10 is further pressed (as shown in FIG. 8), the curve piece 52 of the hooking member 50 would then be pushed by the stapler main body 70, making the hooking member 50 swing, and further making the hook tip 53 hook into the hook hole 34 and pulling the slide member 30 to slide against the supporting member 20. In the midway of sliding of slide member 30, the valve activator 721 is pressed to make the air valve 72 in OPEN mode, thus letting air through to activate single stapling. And then when the slide member 30 slides till its limit, the top part of the slide member 30 would escape the pressure from the safety device 72, and then the compression spring 74 pushes the slide member 30 back till it stays against the front inner wall of the trigger 10 again. Above process then makes a single stapling.

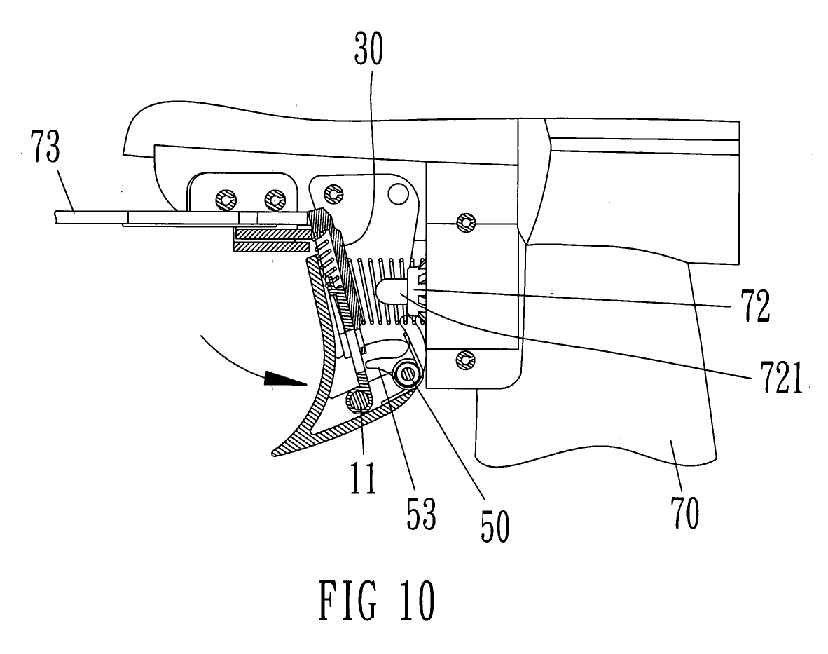

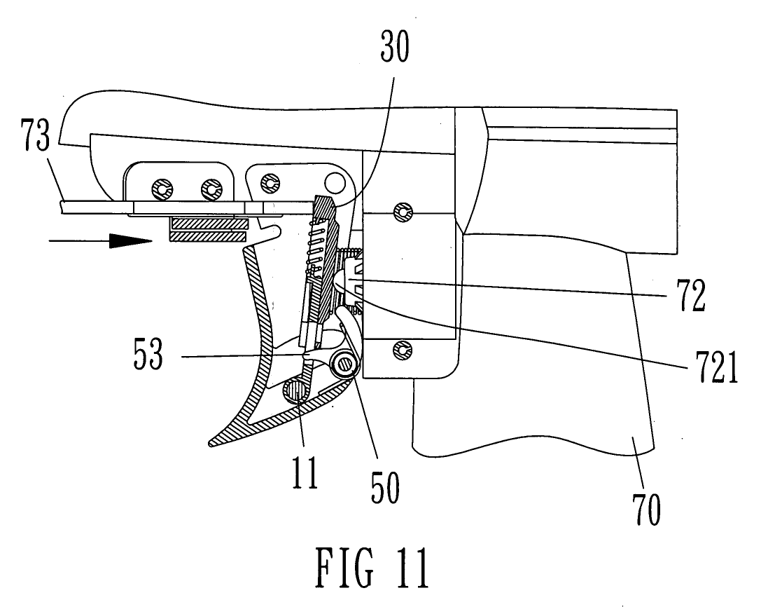

Next please refer to FIGS. 10-12 for illustrations on how continuous-stapling mode works. First, when the trigger 10 is pressed, the curve piece 52 of the hooking member 50 would then be pushed by the stapler main body 70, making the hooking member 50 swing, and making the hook tip 53 move right below hook hole 34. Secondly, push device 72 against the surface of a work piece (not shown in the figures), which will further pushes the top part of slide member 30 to compress the compression spring 74 till the slide member 30 presses the valve activator 721. Thus, the air valve 72 will be in OPEN mode, and it will keep stapling contentiously until the trigger 10 is released. Above process then makes a contentious stapling.

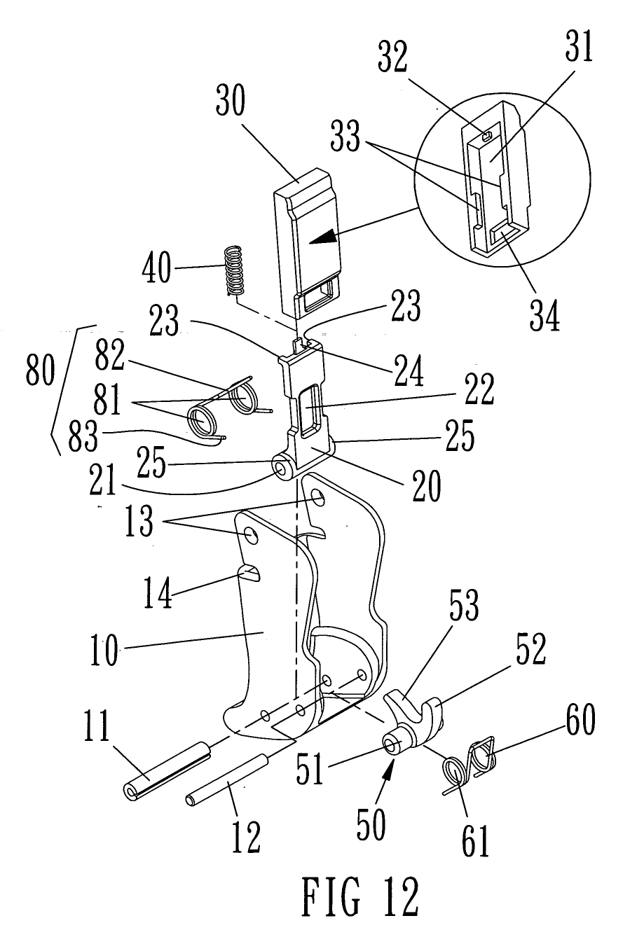

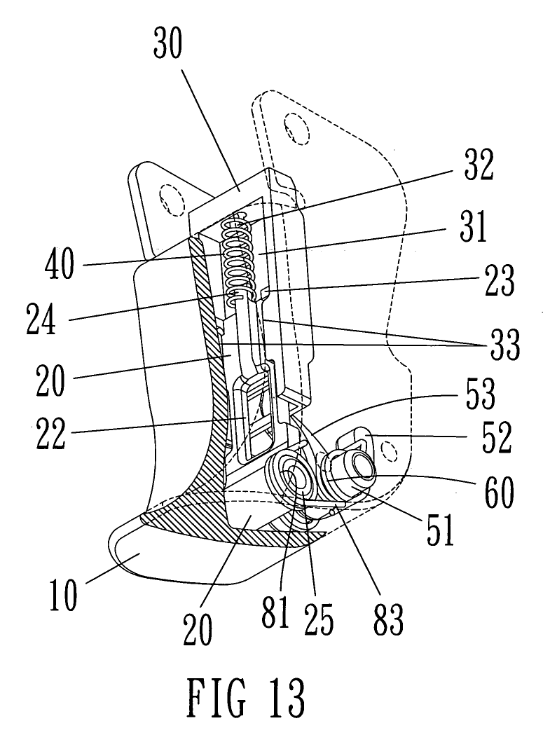

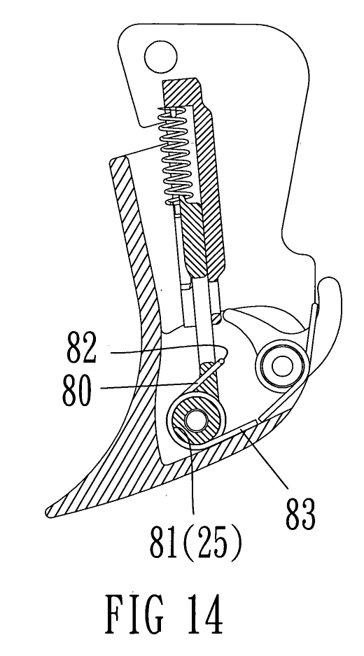

Further please refer to FIGS. 12-14, it is the 2^{nd} preferred embodiment for this invention. Am extra torsion spring 80 can be added on the supporting member 20 so as to push the supporting member 20 always stay against the front inner wall of the trigger 10, which can help push back the safety device 73 to its original position. The detailed feature is: the supporting member 20 further comprises two symmetrical pivot tubes 25 on its both sides so for the torsion spring 80 able to fit on the supporting member 20. The torsion spring 80 has two symmetrical spring holes 81 on its both sides, a connecting bar 82 between the two spring holes 81, and two symmetrical extended feet 83 at its both ends. Due to the torsion force, the connecting bar 82 stays against the back face of the supporting member 20 when assembly, and the extended feet 83 push against the inner bottom face of the trigger 10, therefore the supporting member will be always pushed forward till its designated position as its normal position when the stapler is not in use.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

What is claimed is:

1. A switching mechanism for stapling modes of a stapler that comprises: a trigger, a supporting member, a slide member, a spring, a hooking member and a torsion spring; wherein:
the trigger has a 1^{st} pin, a 2^{nd} pin, and two symmetrical pivot holes and stopper recesses on upper locations of its two sidewalls; the supporting member has pivot holes at its bottom, and a 1^{st} protrusion at its top; the slide member has a sliding recess in one side, a 2^{nd} protrusion on top, and a hook hole at bottom; the spring is connected between the said 1^{st} and 2^{nd} protrusions; the hooking member is connected to the said trigger by the said 2^{nd} pin, and has a curved piece and a hook tip; the torsion spring is fitted on the said hooking member.

2. A switching mechanism for stapling modes of a stapler of claim 1, wherein the said pivot holes of the said trigger are for purpose of connecting the said trigger to the stapler main body.

3. A switching mechanism for stapling modes of a stapler of claim 1, wherein the said trigger is hollow with openings on top and its adjacent rear side for housing the said supporting member, slide member, hooking member, and torsion spring.

4. A switching mechanism for stapling modes of a stapler of claim 1, wherein the said supporting member has a pivot hole at its bottom for fitting with the said 1^{st} pin so as to reach swinging capability.

5. A switching mechanism for stapling modes of a stapler of claim 1, wherein the said supporting member has a penetrating hole near its middle for allowing the said hook tip of the said hooking member to move through during mutual interactions.

6. A switching mechanism for stapling modes of a stapler of claim 1, wherein the said supporting member has symmetrical convex stoppers on top of its sidewall, and the said slide member has an opening at its bottom for allowing sliding purpose and two symmetrical convex blockers in its inner lower middle locations.

7. A switching mechanism for stapling modes of a stapler of claim 1, wherein the said spring is a compression spring.

8. A switching mechanism for stapling modes of a stapler of claim 1, wherein the said hooking member comprises a pivot tube for pivotally fitting with the 2^{nd} pin.

9. A switching mechanism for stapling modes of a stapler of claim 1, wherein the said torsion spring is fitted with the said pivot tube of the said hooking member.

10. A switching mechanism for stapling modes of a stapler of claim 1, wherein both sides of the said torsion spring push against inner bottom face of the said trigger and one side of the said curve piece respectively.

11. A switching mechanism for stapling modes of a stapler of claim 1, wherein the said supporting member further has a torsion spring fitted with it, so that the said supporting member is always pushed to its normal position when the stapler is not in use.

12. A switching mechanism for stapling modes of a stapler of claim 1, wherein the said supporting member further comprises two symmetrical pivot tubes on its both sides with a torsion spring being fitted on it, wherein the said torsion spring has two symmetrical spring holes on its both sides, a connecting bar between the two said spring holes staying against the back face of the supporting member, and two symmetrical extended feet at its both ends pushing against the inner bottom face of the trigger.
